(19) United States
(12) Patent Application Publication
(10) Pub. No.: US 2013/0227532 A1
(43) Pub. Date: Aug. 29, 2013

(54) APPLICATION GENERATION SYSTEM AND METHOD FOR GENERATING AN APPLICATION

(71) Applicant: PANTECH CO., LTD., (US)

(72) Inventor: Sung Chul CHOI, Seoul (KR)

(73) Assignee: PANTECH CO., LTD., Seoul (KR)

(21) Appl. No.: 13/683,246

(22) Filed: Nov. 21, 2012

(30) Foreign Application Priority Data
Feb. 29, 2012 (KR) 10-2012-002132

(51) Int. Cl. G06F 9/45

(52) U.S. Cl. CPC G06F 8/40
USPC 717/136

(57) ABSTRACT

The application generation system includes: a first managing unit to extract at least one execution component from at least one application; and a second management unit to generate an extracted execution component into a container application. The system provides the ability to generate an application configured by extracting operations among the operations of applications stored in a terminal.

### CROSS-REFERENCE TO RELATED APPLICATION

This application claims priority from and the benefit of Korean Patent Application No. 10-2012-0021232, filed on Feb. 29, 2012, which is incorporated by reference for all purposes as if fully set forth herein.

### BACKGROUND

1. Field

The following description relates to an application generation system and method for generating an application.

2. Discussion of the Background

The number of applications that may be executed by a terminal operating system (OS) has increased as terminal OSs, such as, Android™, iOS™, and Bada™, have spread. A terminal may be a smart terminal, a smart phone, a tablet personal computer (PC), a personal digital assistant, a mobile phone, a laptop computer, a desktop computer, etc. An application may have various operations and have a specific operation. When using a great number of applications, there are many cases where a user uses only a particular operation of one application. As the number of applications in a terminal increases, a menu screen, a background screen, and the like displayed on the display unit of the terminal (hereinafter “terminal screen”) may become full and get more and more complex.

FIG. 1 is a diagram of an image displayed on a terminal screen according to the related art. The image of FIG. 1 illustrates the execution of a map application. In the related art, when a subway line map application shown in FIG. 1 is in use, in order to execute another application, the subway line map application is terminated, and a browser may be executed as the other application. This is a general configuration of a method in which a user executes and uses individual applications.

FIG. 2 is a diagram of a terminal system to execute an application according to the related art. Referring to FIG. 2, the configuration of the terminal system to execute the application includes an executing application 210, a non-executing application 230, an OS 250, and a terminal device 270. An application APP1 is executed in the executing application 210, and application APP2, application APP3, application APP4, and application APP5 which are the non-executing applications may be executed when the executing application APP1 is terminated. In this structure there is no application manager operation for managing multitasking of the applications. This may eliminate interference caused by the use of more than one application. For example, the application used by the user may be terminated by an event irrespective of the intention of the user such as a phone call and a short message service (SMS) during usage of the application. Although there is an application in which a use history is stored and is usable according to the use history if terminated, there is inconvenience that the use of the application is terminated and the application has to be restarted. Many of the recently developed terminals are designed to execute a multitasking operation.

FIG. 3 is a diagram of an image displayed on a terminal screen of a multitasking operation according to the related art. FIG. 4 is a diagram of an image displayed on a terminal screen of a multitasking operation according to the related art. FIG. 3 illustrates that various programs may be executed at once, and FIG. 4 illustrates an operation of transferring to a different application while executing the application.

FIG. 5 is a diagram of an image displayed on a terminal system to execute an application according to the related art. Referring to FIG. 5, the configuration of the terminal system for executing the application in the related art includes an executing application 510, a first management unit 530, an OS 550, and a terminal device 570. The first management unit 530 is configured to control and manage screen priority possession right, resource use, and the like of the currently executed application, i.e., the application APP1 in the executing application 510. Accordingly, an operation is provided in which the applications may be used while switching the applications according to a request (i.e., input) of the user or a situation of the terminal, even if various applications (i.e., application APP1 to application APP4) are executed.

In the case of the terminal providing a multitasking operation, for a user to use a new operation, it may be troublesome that the currently used application is terminated or dropped into the background. The terminal may returns to the menu and the new application has to be found and executed.

There are applications which are frequently used among the installed applications. Among the installed applications, there may be applications having a duplication operation, and there may be applications in which one application is provided with various operations. There is a case where the user may call various applications to find a frequently used operation, and a case where the user does not accurately memorize where the frequently used operation is located.

In other words, according to the development of the terminal OS, it is possible to use various applications while transferring and moving between various applications and/or places displayed on the terminal screen using the multitasking operation, but the user may have to enter the menu and find and execute the newly selected application every time.

### SUMMARY

Exemplary embodiments of the present invention provide an application generation system and method for generating an application from operations of applications.

Exemplary embodiments of present invention also provide an application generation system and a method for generating an application in a terminal from execution components of applications stored in the terminal.

Additional features of the invention will be set forth in the description which follows, and in part will be apparent from the description, or may be learned by practice of the invention.

An exemplary embodiment of the present invention an application generation system of a terminal, including: a first management unit to extract an execution component from an application of the terminal, the execution component being a portion of the application; and a second management unit to generate a container application including the execution component.

An exemplary embodiment of the present invention also discloses a method for generating a container application in a terminal, including: extracting an execution component of an application, the execution component being a portion of the application; and generating the container application including the execution component of the application.

An exemplary embodiment of the present invention also discloses a terminal to generate a container application, including: an input/output unit to receive an input; a first management unit to extract data from applications stored in the terminal, the execution component being a portion of the application; a second management unit to generate a container application according to the data; and an operating system to execute the container application according to the input.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram of an image displayed on a terminal screen according to the related art.

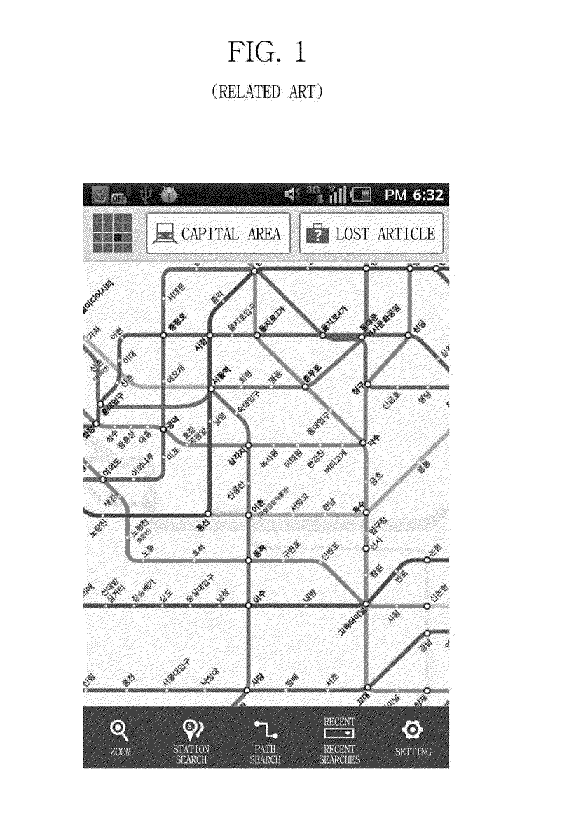

FIG. 2 is a diagram of a terminal system to execute an application according to the related art.

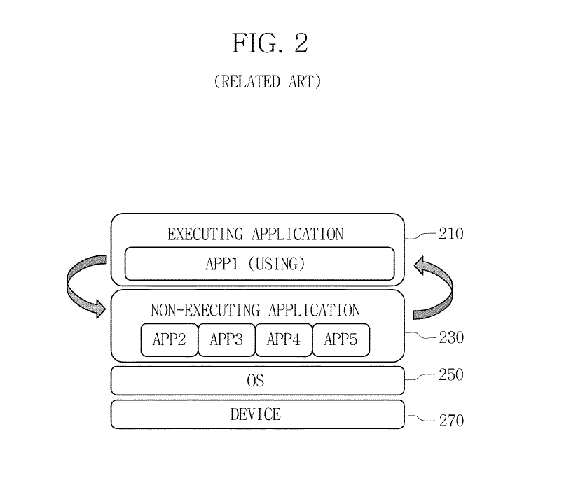

FIG. 3 is a diagram of an image displayed on a terminal screen of a multitasking function according to the related art.

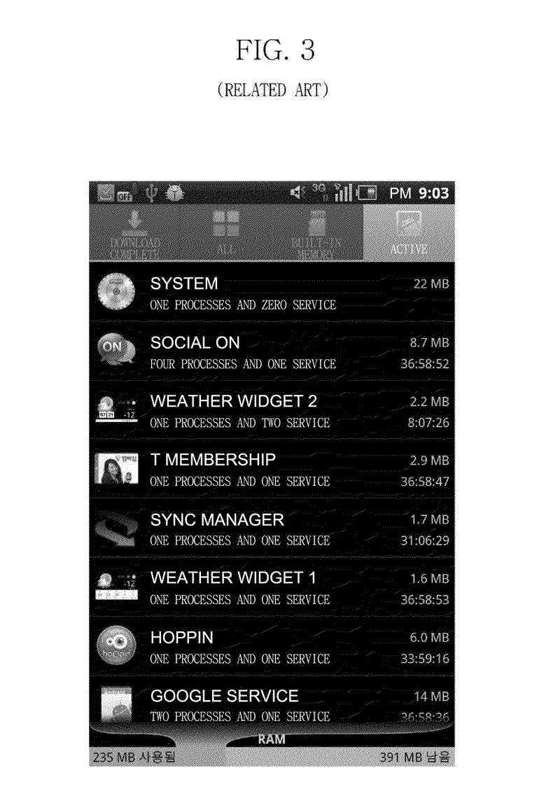

FIG. 4 is a diagram of an image displayed on a terminal screen of a multitasking function according to the related art.

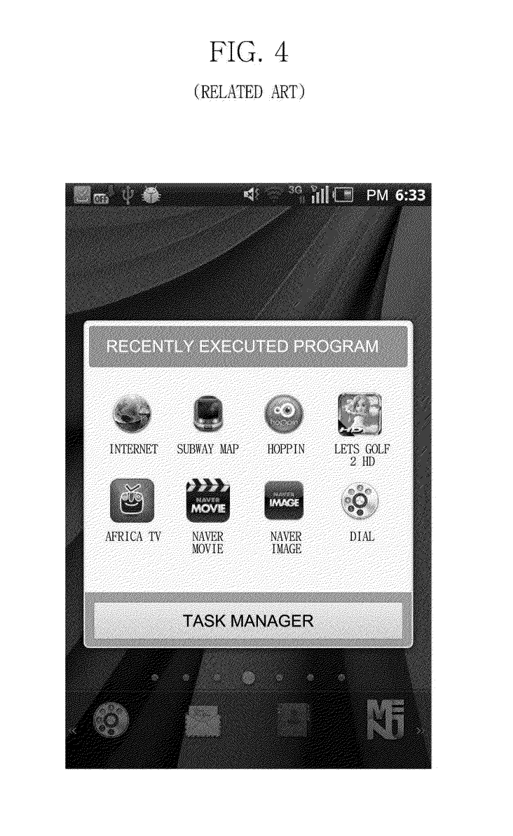

FIG. 5 is diagram of a terminal system to execute an application according to the related art.

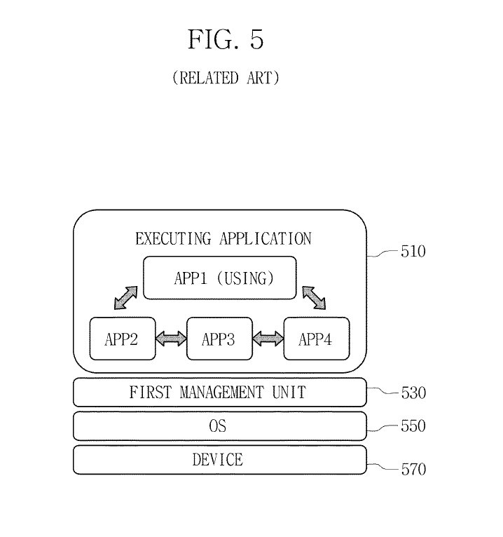

FIG. 6A is a diagram of a relationship between a container application and another application according to an exemplary embodiment of the present invention.

FIG. 6B is a diagram of a relationship between a container application and another application according to an exemplary embodiment of the present invention.

FIG. 6C is a diagram of a relationship between a container application and another application according to an exemplary embodiment of the present invention.

FIG. 7 is a diagram of a container application according to an exemplary embodiment of the present invention.

FIG. 8A is a diagram of an image of a container application displayed on a terminal screen according to an exemplary embodiment of the present invention.

FIG. 8B is a diagram of an image of a container application displayed on a terminal screen according to an exemplary embodiment of the present invention.

FIG. 9 is a diagram of an application generation system according to an exemplary embodiment of the present invention.

FIG. 10 is a diagram of an application generation system according to an exemplary embodiment of the present invention.

### DETAILED DESCRIPTION OF THE ILLUSTRATED EMBODIMENTS

Exemplary embodiments are described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements. Although features may be shown as separate, such features may be implemented together or individually. Further, although features may be illustrated in association with an exemplary embodiment, features for one or more exemplary embodiments may be combinable with features from one or more other exemplary embodiments.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Hereinafter, an application generation system and method for generating an application from partial operations of a plurality of applications will be described in detail with reference to the accompanying drawings.

An execution component may be executed if an application is started, and may refer to a component of an application which may be viewed on a user input/user output (UI) screen of the terminal by a user according to a unit of classification. The execution component may be executed for each application user and/or for each application used. The execution component may be designated by activity in the Android™ OS, a view controller in the iOS™ series, and a page in the Window™ series.

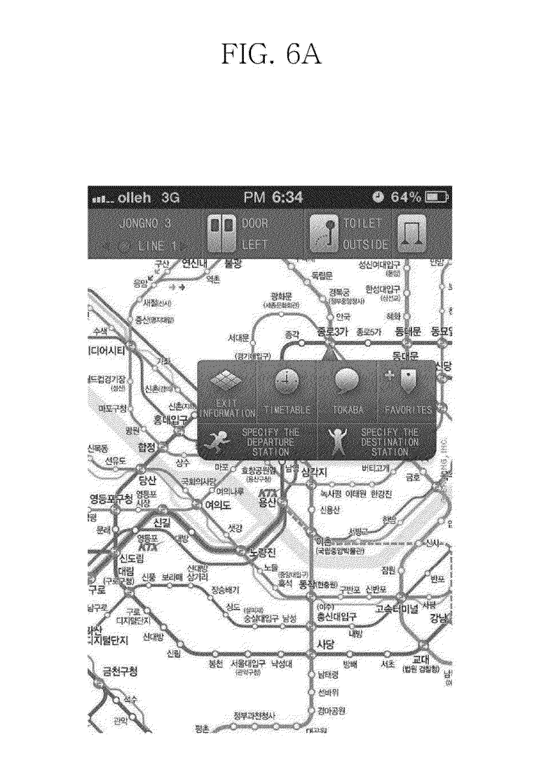

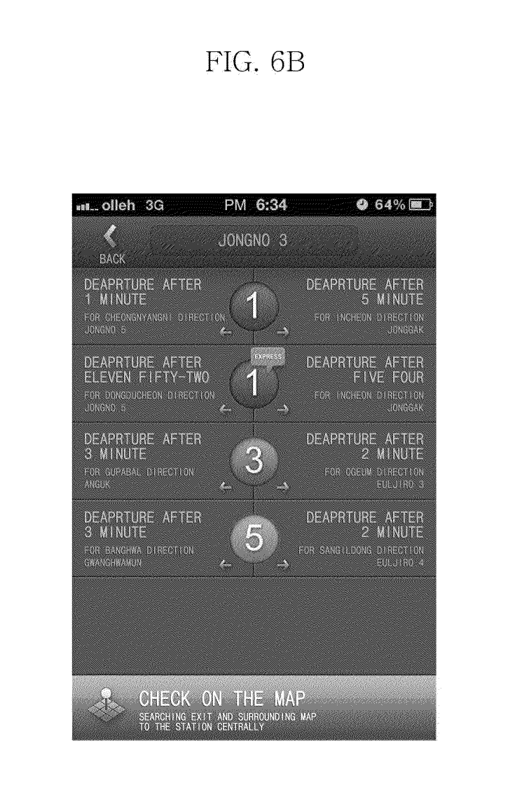

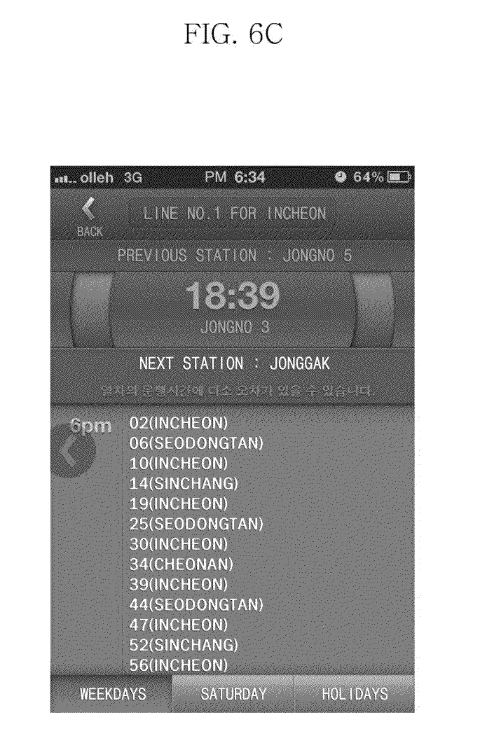

FIG. 6A is a diagram of a relationship between a container application and another application according to an exemplary embodiment of the present disclosure. FIG. 6B is a diagram of a relationship between a container application and another application according to an exemplary embodiment of the present disclosure. FIG. 6C is a diagram of a relationship between a container application and another application according to an exemplary embodiment of the present disclosure.

The execution component is a unit which may be floated or viewed on the terminal screen by selection, for example, a touch, of the user among operations included in a specific application. Floated may refer to a method for displaying images of the execution components to appear as if the execution components may be flipped through or as if the execution components hover within or above the image. The execution component may be a unit which may be floated or viewed on the terminal screen to execute subdivided operations.

Referring to FIG. 6A, a subway navigation application is displayed on a terminal screen. If a user of the subway navigation application selects to execute a timetable for a station stop, for example, station Jongno 3-ga, a specific image appears as shown in FIG. 6B. On the image shown in FIG. 6B, if “to Incheon, Jonggak” is selected at the upper right hand side portion of the image, an operation is executed and a reference image appears as shown in FIG. 6C. FIG. 6B and each sub-divided part or portion of the image of FIG. 6B may be an execution component. For example, “ordinary day,” “Saturday,” and “Holiday” may be the execution component in FIG. 6C. The user may store the execution component shown in FIG. 6B and FIG. 6C in an application.

If a division design method in which the operations of an application are divided into the execution components is not supported by an OS, the OS and the application are configured by a continuous process, and are not divided. A method in which it is possible to perform division design of the execution components of an application to improve development speed and interlocking between the applications has been introduced in recent OS. The exemplary embodiment may be applied to both the OS in which the component is divisionally designed, and the OS in which the components are not divisionally designed, and a method thereof will be described in detail hereinafter.

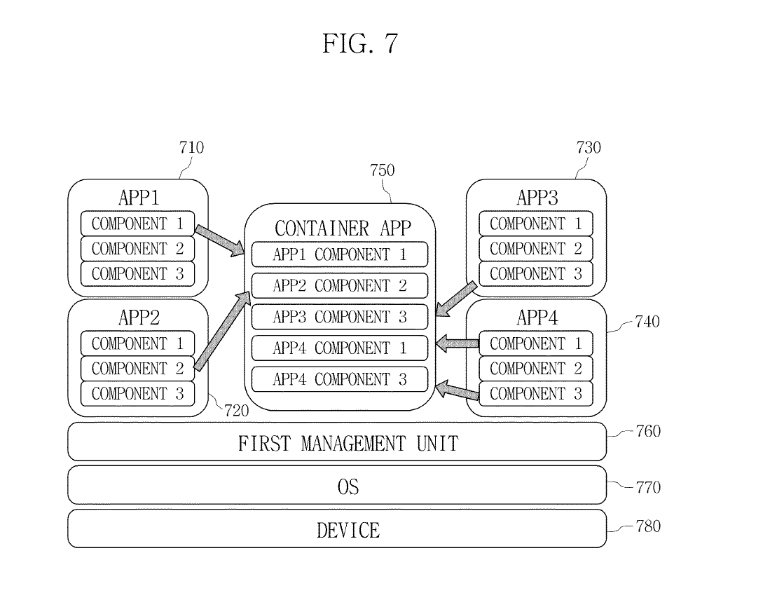

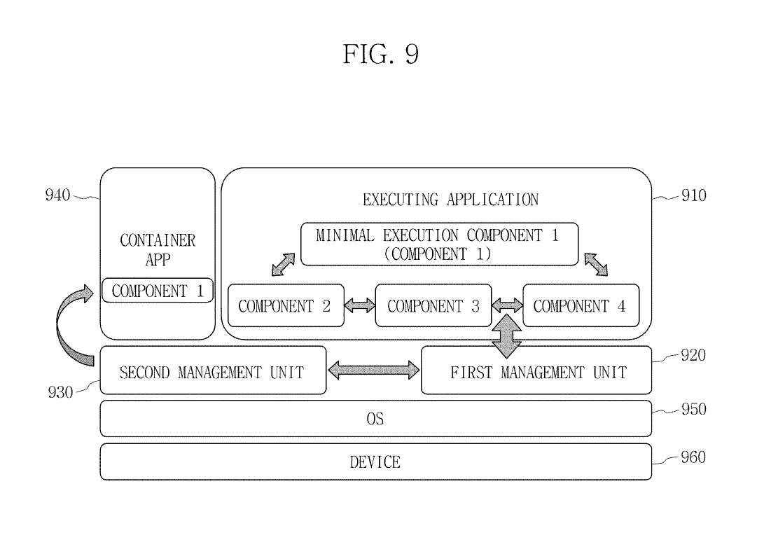

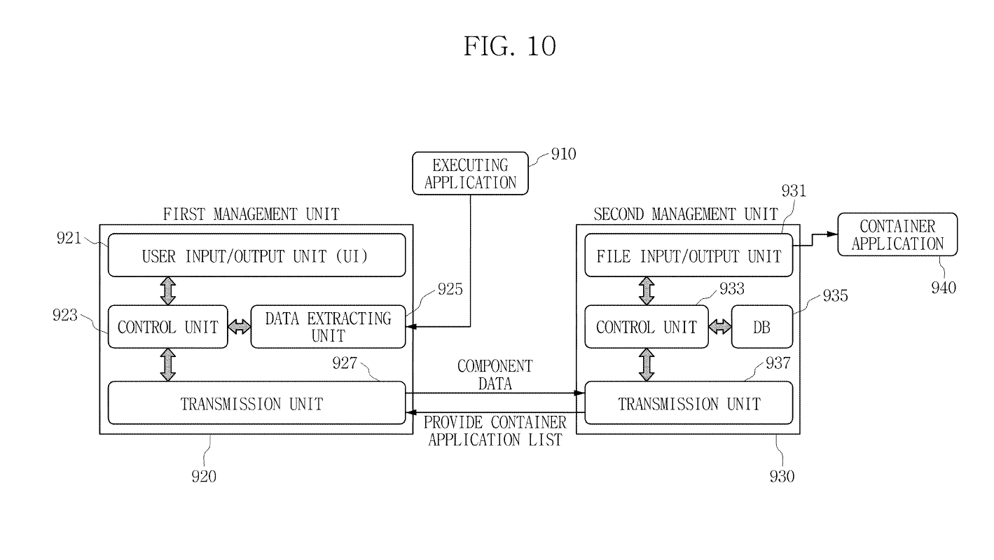

FIG. 7 is a diagram of a container application according to the exemplary embodiments of the present invention. Referring to FIG. 7, an application APP1 710, an application APP2 720, an application APP3 730, and an application APP4 740 are various applications which are available in a terminal. The application APP1 710, the application APP2 720, the application APP3 730, and the application APP4 740 may be provided by the terminal or may be downloaded and installed by the user in the terminal. The component 1, component 2, and component 3 shown in the application APP1 710 the application APP2 720, the application APP3 730, and the application APP4 740 may be execution components. The first management unit 760 may be a program to control, check, and/or to manage an execution state of the application. The operation of the management unit will be described in more detail with reference to FIG. 9 and FIG. 10. The OS 770 may be an operating system used in the terminal, and the device 780 refers to the terminal or may refer to a device control software driver program. The execution components included in the application APP1 710 the application APP2 720, the application APP3 730, and the application APP4 740 are stored in a container application 750. For example, the container application 750 may include the execution component 1 of the application APP1 710, the execution component 2 of the application APP2 720, the execution component 3 of the application APP3 730, and the execution component 1 and execution component 3 of application APP4 740. The container application 750 may be configured by selecting or including partial execution components from the application APP1 710 the application APP2 720, the application APP3 730, and the application APP4 740 according to the user's selection.

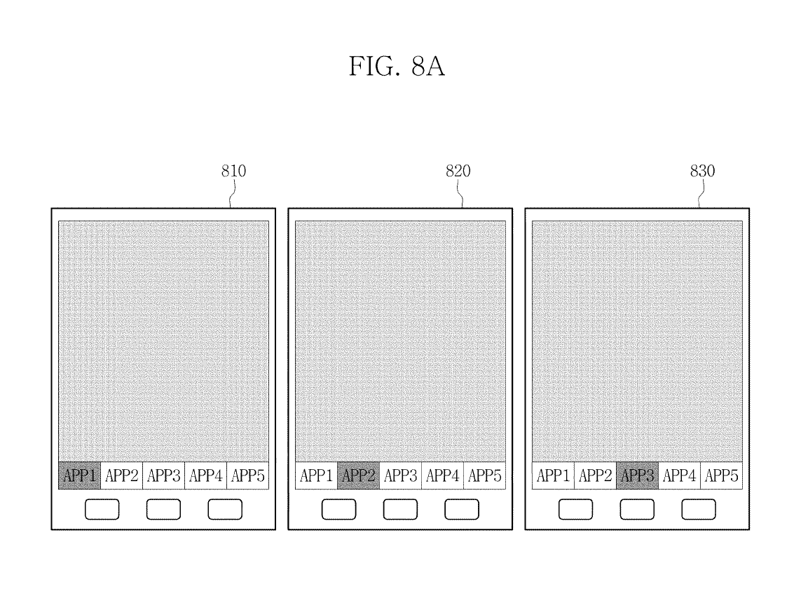

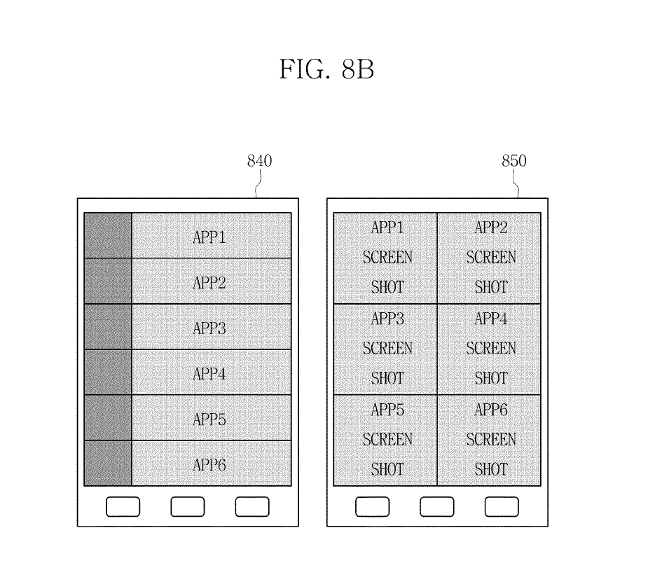

FIG. 8A is a diagram of an image a container application displayed on a terminal screen according to an exemplary embodiment of the present invention. Referring to FIG. 8A, an application APP1, an application APP2, an application APP3, an application APP4, and an application APP5 may refer to execution components of applications which may be stored in the container application. The application APP1, the application APP2, the application APP3, the application APP4, and the application APP5 may be stored in the container application while the applications are executed. Referring to a screen shot 810, if the container application is executed, the application APP1 may be executed. The application APP2, the application APP3, the application APP4, and the application APP5 may be executed by the selection of the user. A screen shot 820 illustrates the application APP2 being executed. A screen shot 830 illustrates the application APP3 being executed. An operation corresponding to each execution component of the application APP1, the application APP2, the application APP3, the application APP4, and the application APP5 may be displayed on the terminal screen. The execution components, i.e., the application APP1, application APP2, the application APP3, the application APP4, and the application APP5, may be arranged horizontally on the bottom of the screen shot. If each execution component, i.e., the application APP1, application APP2, the application APP3, the application APP4, and the application APP5, is selected, the screen shot may be filled with the corresponding operation of the execution component.

FIG. 8B is a diagram of a container application displayed on a terminal screen according to an exemplary embodiment of the present invention. Referring to a screen shot 840 of FIG. 8B, in the screen sot of the container application, an application APP1, an application APP2, an application APP3, and an application APP5 may refer to the execution components of applications which may be stored in the container application. The execution components, i.e., the application APP1, the application APP2, the application APP3, the application APP4, and the application APP5, may be arranged vertically. Referring to a screen shot 850 of FIG. 8B, the container application may include screen shots of the execution components displayed to classify the execution components. The screen shots may be images displayed on the terminal screen if the execution components are stored in the container application. A configuration of a system for configuring such a container application, and an interaction of the configurations will be described.

FIG. 9 is a diagram of an application generation system according to an exemplary embodiment of the present invention. Referring to FIG. 9, the application generation system may include the partial operations of a plurality of applications. The application generation system may include an executing application 910, a first management unit 920, a second management unit 930, a container application 940, an OS 950, and a device 960. The operations of the OS 950 and the device 960 may be similar to the operations described with reference to FIG. 6A, FIG. 6B, and FIG. 6C.

In the executing application 910, the component 1, component 2, component 3, and component 4 may be executed. The component 1, component 2, component 3, and component 4 may be sequentially executed in a specific configuration, for example, circularly. For the user to view the executing component on the terminal screen, the user may float or view only the component 1 on the whole of the terminal screen. The user may divide the terminal screen into a plurality of parts and may simultaneously view the plurality of applications displayed on the plurality of parts. For example, the user may divide the terminal screen in two parts by dividing the screen left/right or up/down, and may view the component 1 in one part of the terminal screen and the component 2 in the other part of the terminal screen. The state where one or more applications are floated or visible on the terminal screen may be referred to as a foreground state, and the state where one or more applications are back so as not to be viewed on the terminal screen may be referred to as a background state. The first management unit 920 may be configured to control the schedule of various applications driven on a platform for the smart terminal.

If the execution component of the executing application is selected in the foreground state, the first management unit 920 may be configured to interact with the second management unit 930 such that the selected execution component is stored in the container application 940. The second management unit 930 may be configured to provide a container application list to the first management unit 920. The second management unit 930 may operate to configure the execution component extracted by the first management unit 920 into the container application 940.

For example, the user may select the execution component 1 in the executing application 910. If the user selects the component, only the execution component 1 may be executed in the foreground state, or at least one of the component 2, component 3, and component 4 with the component 1 may be executed in the foreground state through the terminal screen division, for example, left/right screen division or an up/down screen division. A method for selecting the execution component may be one of various methods, such as, pushing a physical button disposed on the outside of the terminal, touching a terminal screen button on the terminal screen, or shaking the terminal. The user may determine a container application in which the selected execution component is to be stored from among the container applications. The user may select one container application in a container application list or may generate a new container application. If the user selects one container application in the container application list or generates the new container application, the first management unit 920 may extract data about the execution component and may transmit the data to the second management unit 930.

The second management unit 930 may receive the execution component from the first management unit 920, and may configure the container application 940. The second management unit 930 may provide the container application list to the first management unit 920, or requests the first management unit 920 for an application list stored in the terminal. The second management unit 930 may request the application list during the execution of the container application 940.

FIG. 10 is a diagram of an application generation system according to an exemplary embodiment of the present invention. Although FIG. 10 will be described with reference to the features of FIG. 9, exemplary embodiments are not limited thereto. Referring to FIG. 10, the first management unit 920 includes a UI 921, a control unit 923, a data extracting unit 925, and a transmission unit 927. The second management unit 930 includes a file input/output unit 931, a control unit 933, a database (DB) 935, and a transmission unit 937.

There are two cases in which the user may configure the execution component in the container application. One is a case where the user finds the execution component to be stored in the container application while the user views an application on the terminal screen (foreground state). In the first case, the user may store the found execution component in the container application. The container application may be executed in the background state, and may not be executed in a turn-off state.

The second is a case in which the user calls an application and selects the execution component while the user views the container application. The user may store the selected execution component in the container application. The application may be executed in the background state, and may not be executed in a turn-off state.

Hereinafter, a case of extracting the execution component during the use of the application, and a process of extracting the execution component during the using of the container application will be described.

Extraction of Execution Component During Usage of Application

The user may select the execution component to be configured in the container application 940 through the UI 921, during the use of the application. One or more execution components may be selected from one execution component executed in the foreground state or a plurality of execution components executed in the foreground state by the terminal screen division.

The user may input a command for the container application to store the execution component selected by a reference operation to the UI 921. For example, if the execution component to be stored is floated on the terminal screen, a command for the container application to store the execution component selected by touch, drag, long touch, or the like may be input to the UI 921. The UI 921 may command the control unit 923 to call the container application list of the container application 940 in response to the reference operation.

The control unit 923, in response to the command of the UI 921, may request the second management unit 932 for the container application list of the container application 940 through the transmission unit 927. The communication between the first management unit 920 and the second management unit 932 may be performed using the transmission unit 927 and the transmission unit 937 thereof. In other words, the transmission unit 927 and the transmission unit 937 perform transmission/reception operations of the first management unit 920 and the second management unit 930.

The transmission unit 937 of the second management unit 930 receives the request for the container application list, and may transmit the request to the control unit 933. The control unit 933 calls the container application list from the database 935. The database 935 may store the container application list of the container application 940 and the component data to be stored in the container application list. The control unit 933 may store and manage the container application list received from the first management unit 920 in the database 935. The container application list may be selected or newly generated by the user. The control unit 933 may respond to the request for the container application list as described above. The control unit 933 may transmit the container application list received from the database 935 to the transmission unit 927 through the transmission unit 937.

The control unit 923 may provide the container application list received by the transmission unit 927 to a user through the user input/output unit 921. The user may select the container application to configure the execution component from the container application list. The user may generate a new container application. For example, a Hongdae container may be generated to store an execution component about “Hongdae” in a delicious restaurants application in the container application 940 if the container application list includes, for example, Gangnam, Jongno, and Jamsil.

The user may select a container application from the container application list or the control unit 923 may generate a new container application through the UI 921. The control unit 923 may transmits a command to extract the component data about the execution component selected from the executing application 910 selected by the user to the data extracting unit 925.

The data extracting unit 925 may extract the component data from the execution component selected by the user. The extracted component data may include a name of the executed application 910, a name of the execution component, an execution command of the execution component, and additional data to execute the execution component. The data extracting unit 925 may acquire UI layout information of the execution component through the data extracting unit 925 and may collect data, e.g., determination base data to configure the image displayed on the terminal screen.

The data extracting unit 925 may transmit the extracted component data to the control unit 923. The control unit 923 may determine whether the layout of the container application selected by the user on the terminal screen allows for the addition of the extracted component data according to the UI layout information of the execution component. The control unit 923 may recommends a different container application list or lists through the user input/output unit 921 to the user if the selected extracted component data cannot be displayed on the terminal screen. The user may select a recommended container application list to transmit the container application list in which the execution component is to be finally stored, to the control unit 923.

The control unit 923 may transmit the component data and the selected container application list to the transmission unit 937 of the second management unit 930 through the transmission unit 927.

The control unit 933 of the second management unit 930 may store the component data and the container application list received through the transmission unit 937 in the database 935. The container application list stored in the database 935 may be called by the control unit 933 and may be provided to the first management unit 920 if the first management unit 920 requests the component list.

The control unit 933 may transmit the component data and the container application list to the file input/output unit 931. The file input/output unit 931 may store the execution component in the container application list selected by the user of the container application on the basis of the component data and the container application list, or may generate a container application list and stores the execution component in the generated container application list (if the user selects to generate the new container application list).

If the stored execution component is present in the container application 940, it may be updated according to the extracted component data. At the time of executing the container application, the user may delete the unnecessary execution application.

To configure the container application by storing the component data, the OS may support that the application is divisionally designed according to a unit of execution component. Exemplary embodiments may be configured to operate with an OS that may support divisional design and with an OS that may not support divisional design.

If the control unit 923 determines that it is difficult to execute the execution component, the control unit 923 may request the application to store and return used environment data. This may be similar to a case where a game is stored during playing and the game is started at the stored location or part when next started. The state at the time of the exit of the game may be stored, and then the stored state is called (i.e., returned) as it is, at the time of restart.

A producer of the application to be executed in the OS in which it may be difficult to perform the divisional design according to a unit of execution component may be requested for storing and returning of the environment data. The producer may produce an application provided with an operation of storing and returning the environment data for the request of storing and returning of the environment data. The first management unit 920 may request to store and to return the environment data at the time of extracting the execution component, and may store the execution component in the container application according to the environment data acquired through the requesting process.

Extraction of Execution Component During Usage of Container Application

The user may store the execution component in the container application 940 during the use of the application. The application list stored in the terminal may be called and added to the container application 940 during the executing of the container application 940. The application list may be stored during the using of various applications, and the application list may add a function of another application during the execution of the existing container application, and such may be determined by the manufacturer, author, and/or the user.

The user may select to execute the container application 940. The container application may be executed, and the container application 940 may be considered as the executing application 910. The user may execute and edit the container application 940 through the UI 921.

The user may input a command through the UI 921 to request the application list installed in the terminal while using the container application list part of the container application 940 to which the execution component is to be added. The UI 921 may transmit the request for the application list to the control unit 923, and the control unit 923 may provide the application list to the user through the UI 921.

The user may select an application to execute from the application list, and may execute the execution component of the selected application, which is to be stored in the container application 940. The execution component may inputs a command to the UI 921 to store the execution component in the container application according to a reference operation of the user, i.e., touch, drag, long touch, or the like.

The execution component may be extracted at the container application list part in which the execution component is to be stored during the execution of the container application 940. If the execution component is extracted during the use of the application, the operation of providing the container application list to the user and the operation of selecting an execution component from the container application lists may be omitted.

The operation of extracting the component data from the selected execution component and storing the component data in the container application may be the similar to extracting the execution component during the usage of the application.

The user may edit the execution component of the container application during the executing of the application and the executing of the container application.

According to the exemplary embodiments, it is possible to produce an application configured by extracting operations selected by a user from among a plurality of applications in a terminal. The user may collect the execution components of the applications to generate a new application, and may edit and use the new application according to the user's taste.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An application generation system of a terminal, comprising:
a first management unit to extract an execution component from an application of the terminal, the execution component being a portion of the application; and
a second management unit to generate a container application including the execution component.

2. The system of claim 1, wherein the first management unit comprises:
an input/output unit to receive an input;
a data extraction unit to extract the execution component;
a control unit to control the data extraction unit to extract the execution component according to the input; and
a transmission unit to transmit the execution component.

3. The system of claim 2, wherein the second management unit comprises:
a transmission unit to receive the execution component from the first management unit; and
a file input/output unit to generate the container application including the execution component

4. The system of claim 2, wherein the first management unit receives a container application list from the second management unit and the control unit determines whether to generate the container application including the container application list.

5. The system of claim 4, wherein the container application list is a list of container applications stored in the terminal.

6. The system of claim 2, wherein the control unit determines if the execution component may be displayed on the terminal and the control unit determines the location on a terminal screen at which to display the execution component.

7. The system of claim 1, wherein the execution component comprises at least one of a name of the application, a name of the execution component, and an execution command of the execution component.

8. A method for generating a container application in a terminal, comprising:
extracting an execution component of an application, the execution component being a portion of the application; and
generating the container application including the execution component of the application.

9. The method of claim 8, wherein the execution component is extracted from the application while the application is executed.

10. The method of claim 8, wherein the execution component is extracted from the application while the container application is executed.

11. The method of claim 8, wherein the container application comprises more than one execution component.

12. The method of claim 8, further comprising if the execution component is in the container application, updating the container application according to the extracted execution component.

13. The method of claim 8, further comprising determining if the execution component may be displayed, and determining the location and orientation at which to display the execution component.

14. The method of claim 8, wherein the execution component comprises at least one of a name of the application, a name of the execution component, an execution command of the execution component.

15. A terminal to generate a container application, comprising:
an input/output unit to receive an input;
a first management unit to extract data from applications stored in the terminal, the execution component being a portion of the application;
a second management unit to generate a container application according to the data; and
an operating system to execute the container application according to the input.

16. The terminal of claim 15, wherein the first management unit comprises:
an input/output unit to receive an input;
a data extraction unit to extract the data from the applications;
a control unit to control the data extraction unit to extract the data according to the input; and
a transmission unit to transmit the data.

17. The terminal of claim 15, wherein the second management unit comprises:
a transmission unit to receive the data from the first management unit; and
a file input/output unit to generate the container application including the data.

18. The terminal of claim 15, wherein the first management unit receives a container application list from the second management unit and the control unit determines whether to generate the container application according to the container application list.

19. The terminal of claim 15, wherein the container application list is a list of container applications stored in the terminal.

20. The terminal of claim 15, wherein the control unit determines if the execution component may be displayed on the terminal and the control unit determines a location on a terminal screen at which to display the execution component.
